(19) United States
(12) Patent Application Publication
(10) Pub. No.: US 2014/0242457 A1
(43) Pub. Date: Aug. 28, 2014

(54) ALUMINUM ION BATTERY INCLUDING METAL SULFIDE OR MONOCRYSTALLINE VANADIUM OXIDE CATHODE AND IONIC LIQUID BASED ELECTROLYTE

(71) Applicant: CORNELL UNIVERSITY, ITHACA, NY (US)

(72) Inventors: Lynden A. Archer, Ithaca, NY (US); Shyamal Kumar Das, Kamrup (IN); Jayaprakash Navaneedhakrishnan, Ithaca, NY (US)

(73) Assignee: CORNELL UNIVERSITY, ITHACA, NY (US)

(21) Appl. No.: 14/347,320

(22) PCT Filed: Sep. 26, 2012
(86) PCT No.: PCT/US12/57181

§ 371 Date: Mar. 26, 2014

Related U.S. Application Data
(60) Provisional application No. 61/539,102, filed on Sep. 26, 2011.

(51) Int. Cl. H01M 4/48; H01M 4/04; H01M 4/139; H01M 4/58

(52) U.S. Cl. CPC H01M 4/48; H01M 4/5815; H01M 4/0402; H01M 4/139; H01M 2004/021
USPC 429/188; 429/231.5; 429/218.1; 429/223; 429/221; 423/594.17; 423/561.1; 427/126.3; 427/532

(57) ABSTRACT

An aluminum ion battery includes an aluminum anode, a vanadium oxide material cathode and an ionic liquid electrolyte. In particular, the vanadium oxide material cathode comprises a monocrystalline orthorhombic vanadium oxide material. The aluminum ion battery has an enhanced electrical storage capacity. A metal sulfide material may alternatively or additionally be included in the cathode.

### CROSS-REFERENCE TO RELATED APPLICATION

This application is related to, and derives priority from, U.S. Provisional Patent Application Ser. No. 61/539,102, filed 26 Sep. 2011 and titled “Aluminum Ion Battery Including Ionic Liquid Based Electrolyte,” the contents of which are incorporated herein fully by reference.

### BACKGROUND

1. Field of the Invention

Embodiments relate generally to aluminum ion batteries. More particularly, embodiments relate to enhanced performance aluminum ion batteries.

2. Description of Related Art

Since the early 1990s, lithium ion batteries based on a carbonaceous material such as graphite as an anode, a lithiated metal oxide material (LiMO, e.g. LiCoO2) as a cathode and an aprotic liquid as an electrolyte have been the subject of intense scientific and commercial interest within the context of portable electronics applications. In the intervening years, the demand for such secondary/rechargeable batteries with higher operating voltages, improved cycling stability, higher power densities, enhanced safety and lower initial and life cycle costs has increased to meet new needs for smaller, lighter, more powerful electronic devices.

By comparison with lithium, aluminum is the most abundant metal on earth and the third most abundant element in the earth's crust. An aluminum-based redox couple, which involves three electron transfers during the electrochemical charge/discharge reactions, provides competitive storage capacity relative to the single-electron lithium ion battery. Additionally, because of its lower reactivity and easier handling, such an aluminum ion battery might offer significant cost savings and safety improvements over the lithium ion battery platform. Aluminum has consequently long attracted attention as an anode material in an aluminum-air battery because of its high theoretical ampere-hour capacity and overall specific energy.

Given the foregoing enhanced theoretical capacity of an aluminum ion battery with respect to a lithium ion battery, desirable are aluminum ion battery constructions that may feasibly and reliably provide enhanced battery performance, such as enhanced capacity.

### SUMMARY

Embodiments provide a nanostructure that may be used within an electrode such as but not limited to a battery electrode, the electrode that includes the nanostructure and a battery that includes the electrode that includes the nanostructure. Embodiments also provide a method for fabricating an electrode. The particular nanostructure comprises a nano-wire shaped nanoparticle comprising a vanadium oxide (i.e., V₂O₅) material that has a monocrystalline, preferably orthorhombic monocrystalline, crystal structure. Such a nanostructure provides a cathode electrode within an aluminum ion battery with enhanced performance within the context of a greater electrical storage capacity.

Further embodiments also contemplate an electrode (or a related battery comprising the electrode), where the electrode comprises: (1) a conductive substrate; and (2) a coating located upon the conductive substrate, where the coating comprises a metal sulfide material selected from the group consisting of NiS₂, FeS₂, VS₂ and WS₂ metal sulfide materials, preferably having materials properties of the V₂O₅ material, as above. Further embodiments also include monocrystalline nano-wire shaped metal sulfide nanoparticle nanostructures in accordance with the above.

A particular nanostructure in accordance with the embodiments includes a nanoparticle comprising: (1) a V₂O₅ material composition; (2) a monocrystalline structure; and (3) a wire like morphology.

A particular electrode in accordance with the embodiments includes a conductive substrate. The particular electrode also comprises a coating located upon the conductive substrate. The coating comprises a nanoparticle comprising: (1) a V₂O₅ material composition; (2) a monocrstalline structure; and (3) a wire like morphology.

A particular battery in accordance with the embodiments includes an aluminum containing anode. The particular battery also includes a cathode comprising: (1) a conductive substrate; and (2) a coating located upon the conductive substrate. The coating comprises a nanoparticle comprising: (1) a V₂O₅ material composition; (2) a monocrstalline structure; and (3) a wire like morphology. The battery also comprises an electrolyte.

A particular method for fabricating a battery electrode in accordance with the embodiments includes coating upon a conductive substrate a coating composition comprising a nanoparticle comprising: (1) a V₂O₅ material composition; (2) a monocrystalline structure; and (3) a wire like morphology. The method also includes curing the coating composition upon the conductive substrate to provide a cured coating composition upon the conductive substrate.

Another particular nanostructure in accordance with the embodiments includes a nanoparticle comprising: (1) a metal sulfide material composition; (2) a monocrystalline structure; and (3) a wire like morphology.

Another particular electrode in accordance with the embodiments comprises a conductive substrate. This other electrode also includes a coating located upon the conductive substrate, where the coating comprises a metal sulfide material selected from the group consisting of NiS₂, FeS₂, VS₂ and WS₂ metal sulfide materials.

Another particular battery in accordance with the embodiments comprises an aluminum containing anode. This other battery also comprises a cathode comprising: (1) a conductive substrate; and (2) a coating located upon the conductive substrate, where the coating comprises a metal sulfide material selected from the group consisting of NiS₂, FeS₂, VS₂ and WS₂ metal sulfide materials. This other battery also includes an electrolyte.

### BRIEF DESCRIPTION OF THE DRAWINGS

The objects, features and advantages of the embodiments are understood within the context of the Detailed Description of the Embodiments, as set forth below. The Detailed Description of the Embodiments is understood within the context of the accompanying drawings, that form a material part of this disclosure, wherein:

FIG. 1 shows: (a) an XRD pattern; and (b, c) TEM images, of a plurality of V₂O₅ material nanowires that may be used for an aluminum ion secondary battery cathode in accordance with the embodiments.

FIG. 2 shows typical cyclic voltammograms of an aluminum ion battery in accordance with the embodiments using the V₂O₅ material nanowire within a cathode and an aluminum anode in: (a) 1:1 v/v of Al triflate in PC/THF; and (b) 1.1:1 molar ratio of AlCl₃ in ([EMIm]Cl), at a sweep rate of 0.2 mV/s.

FIG. 3 shows: (a) Voltage vs. Time; (b) Voltage vs. Specific Capacity; and (c) cycle life plot of the aluminum ion battery containing the aluminum anode and the V₂O₅ material nanowire cathode and an AlCl₃ in ([EMIm]Cl) ionic liquid electrolyte in accordance with the embodiments, under the potential window 2.5-0.02 V and at a constant current drain of 125 mA/g.

FIG. 4 shows a schematic diagram of an aluminum ion battery in accordance with the embodiments.

### DETAILED DESCRIPTION OF THE EMBODIMENTS

The embodiments provide a nanostructure that may be used within an electrode (i.e., within a cathode electrode) within an aluminum ion battery, the electrode that includes the nanostructure that may be used within the aluminum ion battery and the aluminum ion battery that includes the electrode that includes the nanostructure. The embodiments also include a method for fabricating the electrode that may be used within the aluminum ion battery. In accordance with the embodiments, the particular nanostructure comprises a wirelike nanostructure that comprises a V₂O₅ material composition that has a monocrystalline, preferably orthorhombic monocrystalline, crystal structure.

Additional embodiments include an electrode, such as but not limited to a cathode, and a related battery, where the electrode comprises: (1) a conductive substrate; and (2) a coating located upon the conductive substrate, where the coating comprises a metal sulfide selected from the group consisting of NiS₂, FeS₂, VS₂ and WS₂ metal sulfides.

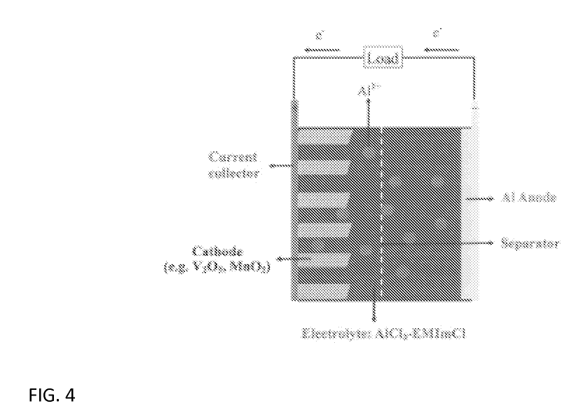

General Considerations of the Aluminum Ion Battery FIG. 4 shows a schematic diagram of an aluminum ion battery in accordance with the embodiments. The aluminum ion battery comprises an aluminum anode that is separated from a cathode (i.e., which is laminated to a cathode collector) by a separator, where each of the foregoing three components (i.e., anode, cathode laminated to cathode collector and separator) is immersed in and wetted by an electrolyte.

With respect to the anode, the anode comprises an aluminum anode material. Such an aluminum anode material may include, but is not necessarily limited to aluminum and aluminum alloy anode materials that may additionally include other alloying elements that are otherwise generally conventional. Such other generally conventional aluminum alloying elements may include but are not necessarily limited to silicon, copper, titanium and vanadium, any of which may be present in amounts that range from parts per million amounts to a few percent amounts.

With respect to the cathode collector, the cathode collector may comprise a cathode collector material including but not limited to a metal conductor cathode collector material and a conducting polymer cathode collector material. Commonly, the cathode collector comprises a stainless steel cathode collector material or an alternative cathode collector material that is otherwise less susceptible to corrosion within the particular electrolyte that is illustrated in FIG. 4 or alternatively may be used within the aluminum ion battery that is illustrated in FIG. 4.

The cathode as illustrated within the schematic diagram of FIG. 4 comprises a V₂O₅ material that furthermore has a nanowire morphology and a monocrystalline orthorhombic crystal structure. The nanowire morphology has a nanowire length of up to about one centimeter and a nanowire cross-sectional diameter from about 10 to about 1000 nanometers. As an alternative to V₂O₅ nanowires, the embodiments also contemplate metal sulfide materials, such as but not limited to NiS₂, FeS₂, VS₂ and WS₂ metal sulfide materials for a cathode material, where the metal sulfide materials may otherwise have the same dimensional and morphological constraints as the foregoing V₂O₅ material.

Finally, the electrolyte comprises an ionic liquid electrolyte. While the example that follows provides a specific example of an ionic liquid electrolyte the embodiments are by no means so limited, and to that end various alternative ionic liquid electrolytes are also considered within the context of the embodiments. Such alternative ionic liquid electrolyte compositions may include but are not necessarily limited to ionic liquid compositions as listed within Brown et al., U.S. Patent Application Publication Number 2012/0082904 and 2012/0082905, all of the contents of which are incorporated herein fully by reference.

Finally, notable within the context of the embodiments is that an aluminum ion battery in accordance with the embodiments may have an electrical power density in a range of about 270 to about 310 mAhr/g (i.e., at least about 270 mAhr/g).

Specific Embodiment of the Aluminum Ion Battery A specific embodiment provides a novel aluminum ion battery system that uses V₂O₅ material nanowires as a cathode against an aluminum metal anode in an ionic liquid (IL), 1-ethyl-3-methylimidazolium chloride ([EMIm]Cl) with aluminum chloride (AlCl₃) based electrolyte. Trimethylphenylammonium chloride (TMPAC) or n-butylpyridinium chloride ionic liquid may also be used. As well, a mixture of aluminum chloride, lithium chloride and dimethyl sulfone may also be used. Such an aluminum ion battery in accordance with the embodiments offers evidence of stable electrochemical behavior with extended cycle life data. The specific aluminum ion battery in accordance with the specific embodiment delivered a discharge capacity of about 305 mAh/g in a first cycle and about 273 mAh/g after 20 cycles. One may attribute the favorable performance characteristics of the aluminum ion battery in accordance with the specific embodiment to the synergistic effect of a suitable ionic liquid electrolyte, the V₂O₅ material nanowire cathode and the aluminum anode. Specifically, a significant consideration for achieving high energy density of an aluminum ion battery in accordance with the specific embodiment is an electrolyte having good ionic conductivity for Al³⁺, a wide electrochemical stability window in the presence of metallic aluminum and an ability to wet and permeate the pores of a metal oxide cathode. The apposite electrolyte should also facilitate and foster reversible electrochemical deposition and dissolution of aluminum.

Aluminum chloride (AlCl₃) dissolved in 1-ethyl-3-methylimidazolium chloride ([EMIm]Cl) was used as an electrolyte in the current study to examine the operation of an aluminum ion battery in accordance with the embodiments at room temperature (25° C.). This electrolyte possesses different degrees of Lewis acidity depending on [EMIm]Cl:AlCl₃ ratio, which provides an additional degree of freedom in tuning its properties. During discharge the prevalent AlCl₄⁻ anion in the electrolyte will react with the aluminum anode to form Al₂Cl₇ complex species, which react with the cathode to form an aluminum intercalated V₂O₅ discharge product. An acidic electrolyte composition with 1.1:1 molar ratio of AlCl₃ to ([EMIm]Cl) was found to yield effective electrochemical deposition and dissolution of aluminum and was therefore used for the study. To verify the role played by the AlCl₃-[EMIm]Cl electrolyte, electrochemical investigation of the same battery system was also performed with an electrolyte including aluminum trifluromethanesulfonate (Al triflate) dissolved in a conventional aprotic liquid cocktail PC/THF (1:1 v/v). In contrast with the AlCl₃-[EMIm]Cl electrolyte system, no electrochemical activity was observed in the measured voltage range −0.75-4.2 V, underscoring the importance of the IL-based electrolyte.

The V₂O₅ nano-wires used for the cathode were prepared by a hydrothermal method. In a typical synthesis, 0.364 g of commercial V₂O₅ powder (Sigma-Aldrich) and 30 ml of DI H₂O were mixed under vigorous magnetic stirring at room temperature, and then 5 ml 30% H₂O₂ (Sigma-Aldrich) was added to this mixed solution and kept continuously stirred for 30 min. Finally a transparent orange solution was obtained. The resultant solution was then transferred to a 40 ml glass lined stainless steel autoclave and heated 205° C. for 4 days. The product was washed with anhydrous ethanol and distilled water several times. Finally. it was dried at 100° C. for 12 h and then annealed at 500 ° C. for 4 h in air. The synthesized product was characterized by Transmission Electron Microscopy (TEM, Tecnai, T12, 120 kV), powder X-ray diffraction (Scintage X-ray diffractometer with Cu Kα radiation), cyclic voltammetry (Solartron's Cell Test model potentiostat under the scan rate of 0.2 mV/s), and galvanostatic electrochemical charge discharge analysis (Maccor cycle life tester, under the potential window 2.5-0.02 V).

The V₂O₅ cathode slurry was made by mixing 85% of the synthesized V₂O₅ nano wires, 7.5% super-p carbon and 7.5% of PVDF binder in NMP dispersant. Electrodes were produced by coating the slurry on a 10 micron stainless steel current collector at 105° C. for 1 h initially and at 100° C. for 4 h in a vacuum oven. Since the acidic electrolyte used has the tendency to etch copper, stainless steel was used as the current collector. The resulting slurry-coated stainless steel foil was roll-pressed and the electrode was reduced to the required dimensions with a punching machine. Preliminary cell tests were conducted on 2032 coin-typel cells, which were fabricated in an argon-filled glove box (AlCl₃ is highly reactive) using 10 micron Al metal as the counter electrode and a Whatman glass microfiber separator. The electrolyte solution was 1.1:1 anhydrous AlCl₃ in 1-ethyl-3-methylimidazolium chloride.

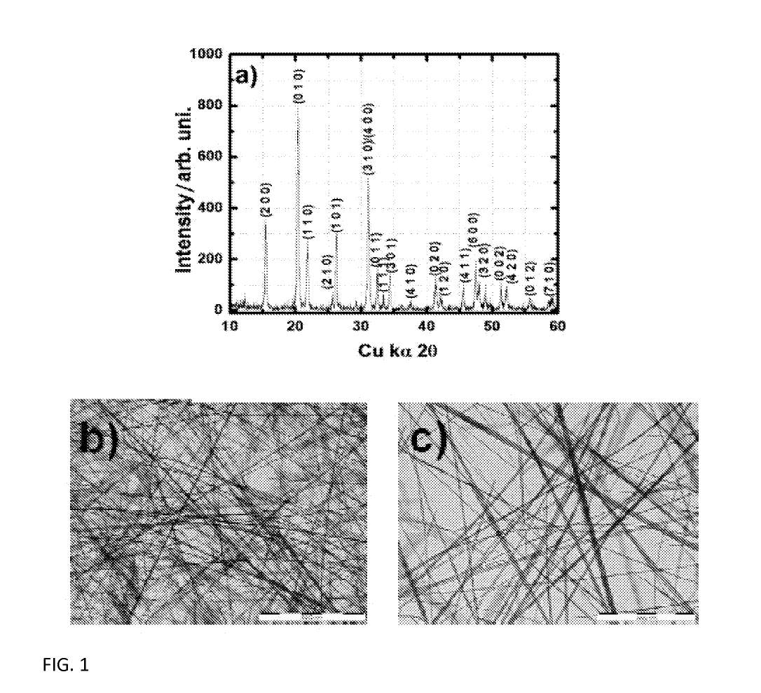

The phase purity and degree of structural order of the synthesized V₂O₅ was studied using powder X-ray diffraction (XRD) pattern shown in FIG. 1a. The XRD obtained is in good agreement with the standard JCPDS pattern (File No. 89-0612) and shows the existence of phase pure orthorhombic V₂O₅ with Pmmn space group. The absence of any undesirable peaks demonstrates the presence of phase pure product and the miller indices (hkl) of all the characteristic peaks are marked as per the standard pattern. FIGS. 1b-c shows the transmission electron microscopy (TEM) image of the as synthesized V₂O₅ nano-wires. It is apparent that the synthesis procedure yields uniform and nearly monodispersed nanostructures having uniform diameters throughout their entire lengths.

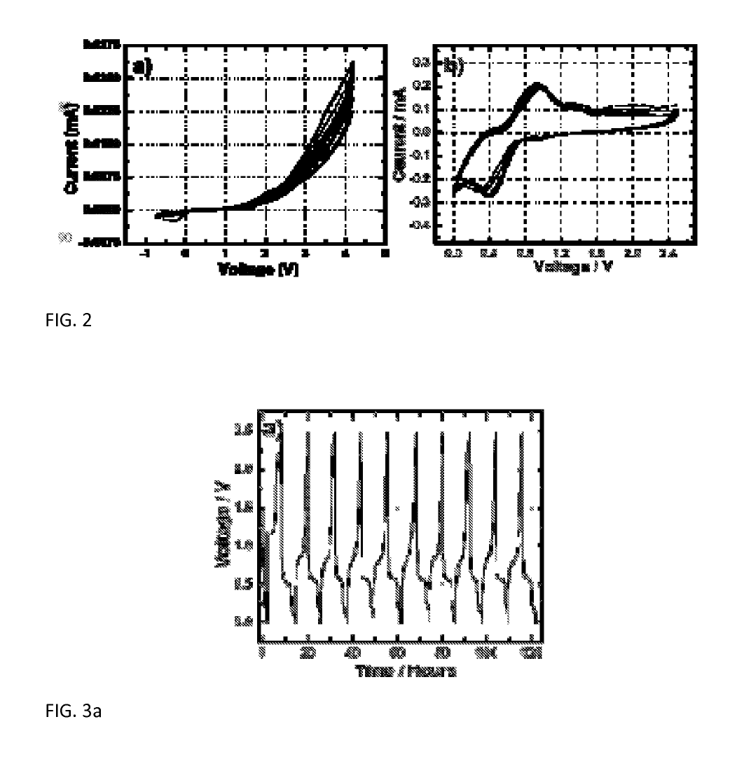

To evaluate the feasibility of the electrolyte and the synthesized V₂O₅ nano-wires for aluminum ion battery applications, electrochemical properties were examined by cyclic voltammetry and galvanostatic cycling analysis. FIGS. 2a-b show the cyclic voltammograms of the V₂O₅ cathode against aluminum metal anode in two different electrolytes: 1:1 v/v of Al triflate in PC/THF (FIGS. 2a) and 1.1:1 molar ratio of AlCl₃ in [EMIm]Cl (FIG. 2b) at room temperature. As mentioned earlier, no electrochemical activity was observed for the aluminum ion battery using Al triflate in PC/THF as the electrolyte and V₂O₅ nano-wire cathode in the measured voltage range of −0.75-4.2 V. On the other hand, a pair of cathodic and anodic peaks was observed for the aluminum ion battery with V₂O₅ nano-wire cathode and AlCl₃ in [EMIm]Cl electrolyte under the potential window of 2.5-0.02 V. The CV pattern shown in FIG. 2b exhibited a cathodic peak at ˜0.45 V and a corresponding anodic peak at ˜0.95 V, respectively, which may be attributed to the insertion/deinsertion of Al³⁺ ions into and from the orthorhombic crystal lattice structure of V₂O₅ nano-wires. Virtually no change in the peak position or peak current value was observed in the cyclic voltammogram shown in FIG. 2b even after 20 scans which substantiates the electrochemical stability of the battery. For this reason, AlCl₃ in [EMIm]Cl was chosen as the electrolyte for discharge/charge studies.

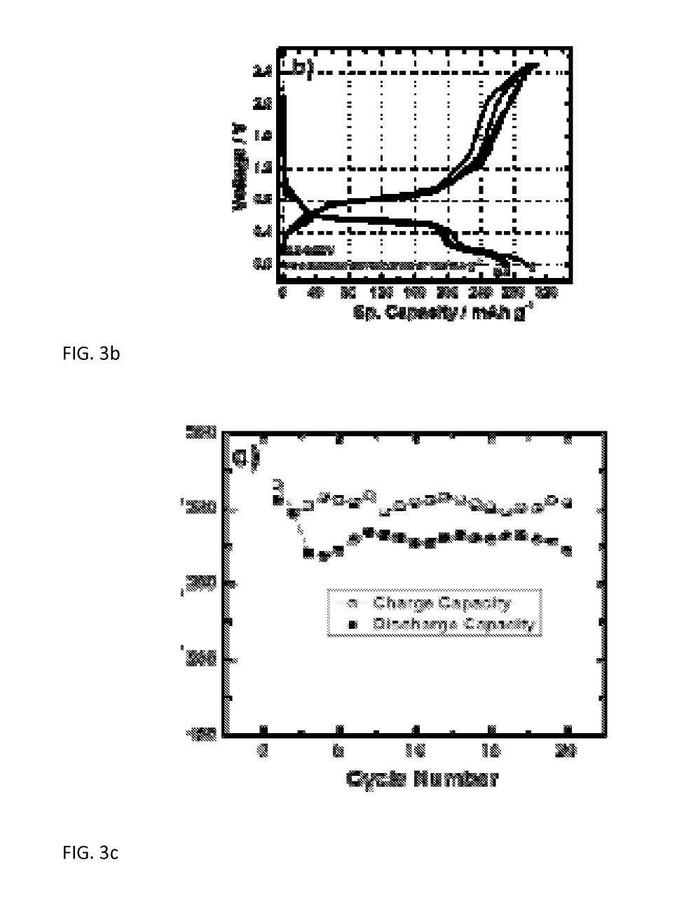

To further evaluate the electrochemical properties of the designed aluminum ion battery, galvanostatic discharge/charge reaction was performed in the cell voltage of 2.5-0.02 V at a constant current drain of 125 mA/g. The open circuit voltage of the aluminum ion battery was found to be 1.8 V. FIG. 3a displays the voltage vs. time plot of the aluminum ion battery, wherein no change in the potential of Al³⁺ insertion/extraction plateau was observed. FIG. 3b shows the voltage vs capacity plot of the aluminum ion battery which demonstrates a well defined and very stable Al³⁺ insertion plateau at ˜0.55V. In the first cycle, the battery exhibited an Al³⁺ ion insertion capacity of 305 mAh/g against 273 mAh/g at the end of 20 cycles. These values are somewhat lower than the theoretical capacity of V₂O₅ against Al³⁺ ion, which is estimated to be 442 mAh/g considering a simple three electron transfer reaction (Al+V₂O₅⇄AlV₂O₅). FIG. 3c shows cycling performance of the aluminum ion battery, which shows a high degree of reversibility. Significant studies are underway to understand how the current density influences the practical specific capacity achieved in the aluminum ion battery and to shed greater light on the simple intercalation-deintercalation reaction proposed. Indeed based on the lower specific capacities observed experimentally one might conclude that only about 0.7 moles of Al³⁺ ions appear to participate in the actual redox reaction. As in the case of lithium ion secondary batteries, one may anticipate significant opportunities for nanoscale engineering and chemical design of the aluminum ion battery cathode to increase the overall cell potential. Additionally, one may anticipate as significant efforts to pioneer ionic liquid and other aluminum ion conducting electrolytes to enhance cell performance at high voltages and current drains.

In conclusion, the embodiments describe a novel aluminum ion rechargeable battery exploiting V₂O₅ or alternative metal sulfides as a cathode against aluminum metal anode in an ionic liquid-based electrolyte. When evaluated, the battery displayed promising electrochemical features with stable cycling behavior over 20 cycles. The energy density of the aluminum ion battery was calculated to be 240 Wh/kg, which may be limited, but considering the other attractive attributes of an aluminum based battery platform, one may anticipate rapid and sustained improvements.

All references, including publications, patent applications, and patents cited herein are hereby incorporated by reference in their entireties to the extent allowed, and as if each reference was individually and specifically indicated to be incorporated by reference and was set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein is merely intended to serve as a shorthand method of referring individually to each separate value falling within the range, unless otherwise indicated herein, and each separate value is incorporated into the specification as if it was individually recited herein.

All methods described herein may be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

What is claimed is:

1. A nanoparticle comprising:
a V₂O₅ material composition;
a monocrystalline structure; and
a wire like morphology.

2. The nanoparticle of claim 1 wherein the monocrystalline structure is an orthorhombic monocrystalline structure.

3. The nanoparticle of claim 1 wherein the wire like morphology has a length of up to about one centimeter and a diameter from about 10 to about 1000 nanometers.

4. An electrode comprising:
a conductive substrate; and
a coating located upon the conductive substrate, the coating comprising a nanoparticle comprising:
a V₂O₅ material composition;
a monocrstalline structure; and
a wire like morphology.

5. The electrode of claim 4 wherein the conductive substrate comprises stainless steel.

6. The electrode of claim 4 wherein the monocrystalline structure is an orthorhombic monocrystalline structure.

7. The electrode of claim 4 wherein the wire like morphology has a length of up to about one centimeter and a diameter from about 10 to about 1000 nanometers.

8. A battery comprising
an aluminum containing anode;
a cathode comprising:
a conductive substrate; and
a coating located upon the conductive substrate, the coating comprising a nanoparticle comprising:
a V₂O₅ material composition;
a monocrstalline structure; and
a wire like morphology; and
an electrolyte.

9. The battery of claim 8 wherein the aluminum containing anode comprises aluminum.

10. The battery of claim 8 wherein the conductive substrate comprises stainless steel.

11. The battery of claim 8 wherein the monocrystalline structure is an orthorhombic monocrystalline structure.

12. The battery of claim 8 wherein the wire like morphology has a length of up to about one centimeter and a diameter from about 10 to about 1000 nanometers.

13. The battery of claim 8 wherein the electrolyte comprises an ionic liquid electrolyte.

14. The battery of claim 13 wherein the ionic liquid electrolyte comprises a 1-ethyl-3-methylimidazolium chloride ionic liquid electrolyte.

15. The battery of claim 14 wherein the ionic liquid electrolyte further comprises aluminum chloride.

16. A method for fabricating an electrode comprising:
coating upon a conductive substrate a coating composition comprising a nanoparticle comprising:
a V₂O₅ material composition;
a monocrystalline structure; and
a wire like morphology; and
curing the coating composition to provide a cured coating composition.

17. The method of claim 16 wherein the composition further comprises a conductive additive.

18. The method of claim 16 wherein the composition further comprises a carrier solvent.

19. The method of claim 16 wherein the composition is thermally cured.

20. The method of claim 16 wherein the composition is radiation cured.

21. A nanoparticle comprising:
a metal sulfide material composition;
a monocrystalline structure; and
a wire like morphology.

22. The nanoparticle of claim 21 wherein the metal sulfide material is selected from the group consisting of NiS₂, FeS₂, VS₂ and WS₂ metal sulfide materials.

23. An electrode comprising:
a conductive substrate; and
a coating located upon the conductive substrate, the coating comprising a metal sulfide material.

24. The electrode of claim 23 wherein the metal sulfide material is selected from the group consisting of NiS₂, FeS₂, VS₂ and WS₂ metal sulfide materials.

25. The electrode of claim 23 wherein the metal sulfide material comprises:
a monocrystalline structure; and
a wire like morphology.

26. A battery comprising
an aluminum containing anode;
a cathode comprising:
a conductive substrate; and
a coating located upon the conductive substrate, the coating comprising a metal sulfide material; and
an electrolyte.

27. The battery of claim 26 wherein the metal sulfide material is selected from the group consisting of NiS₂, FeS₂, VS₂ and WS₂ metal sulfide materials.

28. The electrode of claim 26 wherein the metal sulfide material comprises:
a monocrystalline structure; and
a wire like morphology.
